(19) United States
(12) Patent Application Publication
(10) Pub. No.: US 2013/0191510 A1
(43) Pub. Date: Jul. 25, 2013

(54) METHOD FOR ACCESSING A FILE IN A NETWORK STORAGE DEVICE

(71) Applicants: Shih-Chia Huang, Taipei City (TW); Tsang-Yi Chen, New Taipei City (TW)

(72) Inventors: Shih-Chia Huang, Taipei City (TW); Tsang-Yi Chen, New Taipei City (TW)

(21) Appl. No.: 13/354,338

(22) Filed: Jan. 20, 2012

(51) Int. Cl. G06F 15/16

(52) U.S. Cl. 709/219

(57) ABSTRACT

A method for accessing a file in a network storage device is disclosed. The method includes receiving a file transmitting request from a first electronic device via the network for accessing the file; transmitting an authorization request corresponding to the file transmitting request to a second electronic device via the network; receiving a reply corresponding to the authorization request from the second electronic device; and transmitting the file to the first electronic device via the network when the reply notices that the file is accessible.

### BACKGROUND

1. Technical Field

The present invention relates to a method for accessing a file in a network storage device, and more particularly, to a method for accessing a file in a network storage device according to an authorization reply.

2.Description of the Conventional Art

As related technology keeps improving, various types of storage devices, such as memory sticks and hard disks, are developed for purposes of storing data. Some of the storage devices are capable of coupling to a network for providing data access to a plurality of users. In the prior art, in order to provide data access via a network, an account and a corresponding password must be preset in a network storage device for providing data security to ensure privacy of files stored in the network storage device. However, according to such an arrangement, different users possess the same authority level to access files in the network storage device after logging in. In order to enhance data security, an authority level of each user must be further preset in the network storage device, such that different users with different authority levels are allowed to access files with corresponding authority levels. However, the authority level of each user must be set one-by-one, which is a tedious and time-consuming process.

### SUMMARY

The present invention provides a file accessing method via a network for a network storage device having at least one file stored therein. The method comprises receiving a file transmitting request from a first electronic device via the network for accessing the file; transmitting an authorization request corresponding to the file transmitting request to a second electronic device via the network; receiving a reply corresponding to the authorization request from the second electronic device; and transmitting the file to the first electronic device via the network when the reply notices that the file is accessible.

The present invention further provides a network storage device. The network storage device comprises a memory unit for storing data, and a control unit, for controlling access of the data stored in the memory unit. Wherein when a first electronic device transmits a file request to the network storage device via a network for accessing a file stored in the memory unit, the control unit transmits an authorization request to a second electronic device via the network for asking whether the file is accessible by the first electronic device; and wherein when the second electronic device transmits a reply to notice the network storage device that the file is accessible by the first electronic device, the control unit transmits the file to the first electronic device via the network.

The present invention further provides a data transmitting system. The data transmitting system comprises a network storage device, a client electronic device coupled to the network storage device via a network, and an owner electronic device coupled to the network storage device via the network. The network storage device comprises a first memory unit for storing at least one file, and a control unit coupled to the first memory unit for controlling access of the at least one file stored in the first memory unit. Wherein when the client electronic device transmits a file request to the network storage device via the network for accessing the at least one file stored in the first memory unit, the control unit transmits an authorization request to the owner electronic device via the network for asking whether the at least one file is accessible by the client electronic device; and wherein when the owner electronic device transmits a reply to notice the network storage device that the at least one file is accessible by the client electronic device, the control unit transmits the at least one file to the client electronic device via the network.

The present invention further provides another file accessing method via a network for a network storage device . The method comprises generating a file request to the network storage device; generating an authorization request in response to the file request to ask whether a file quested by the file request is accessible; generating a reply corresponding to the authorization request to determine whether the file is able to be delivered from the network storage device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing a network storage device of the present embodiment.

FIG. 2A is a diagram illustrating a wireless file transferring system performing a method for accessing a file in the network storage device of the present embodiment.

FIG. 2B is a diagram illustrating another wireless file transferring system performing a method for accessing a file in a network storage device of another embodiment.

FIG. 2C is a diagram illustrating another wireless file transferring system performing a method for accessing a file in a network storage device of another embodiment.

FIG. 3 is a diagram showing another network storage device of the present embodiment.

FIG. 4 is a flowchart of the method of the present embodiment for accessing files in the network storage device.

### DETAILED DESCRIPTION

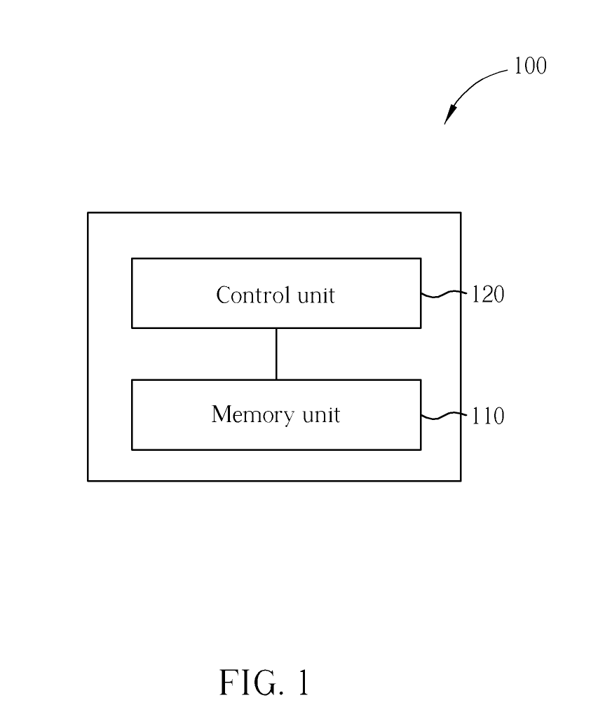

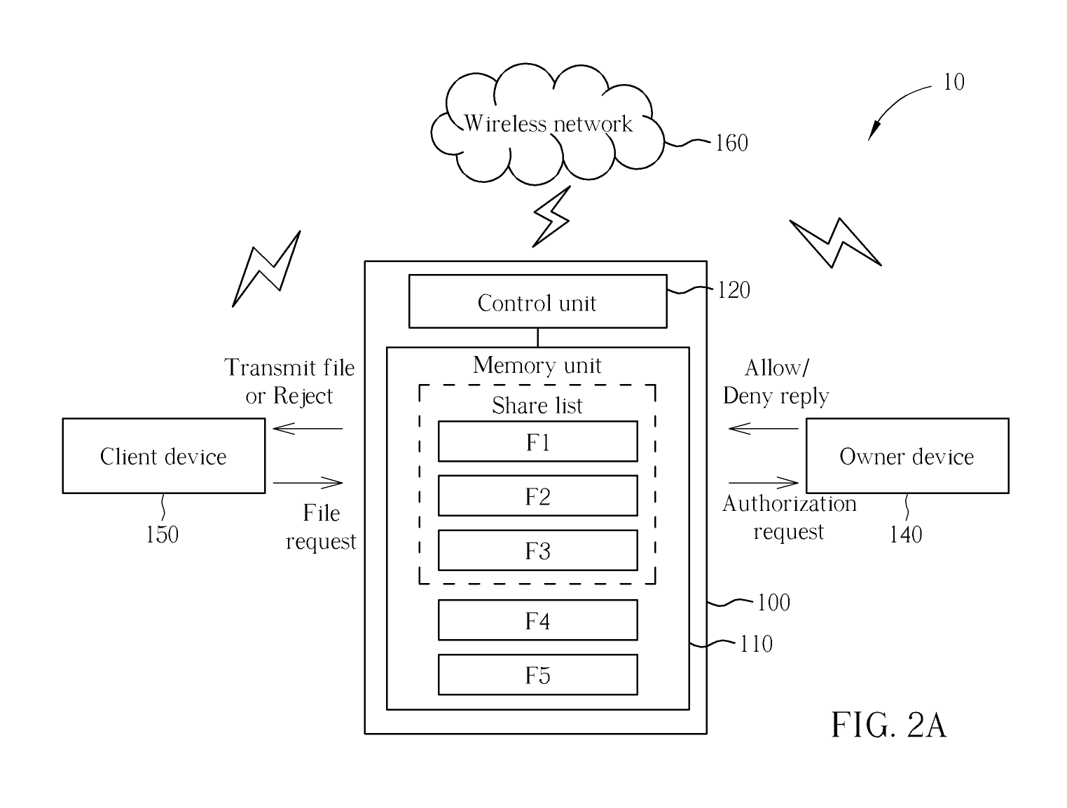

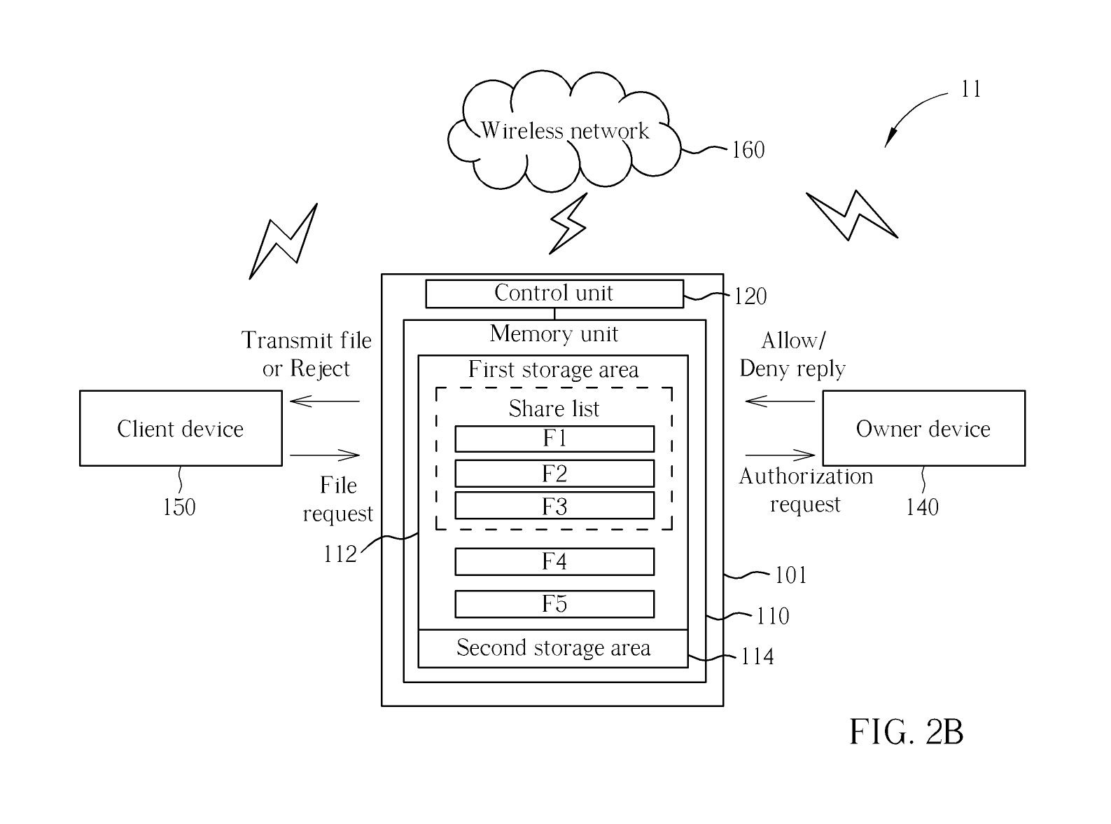

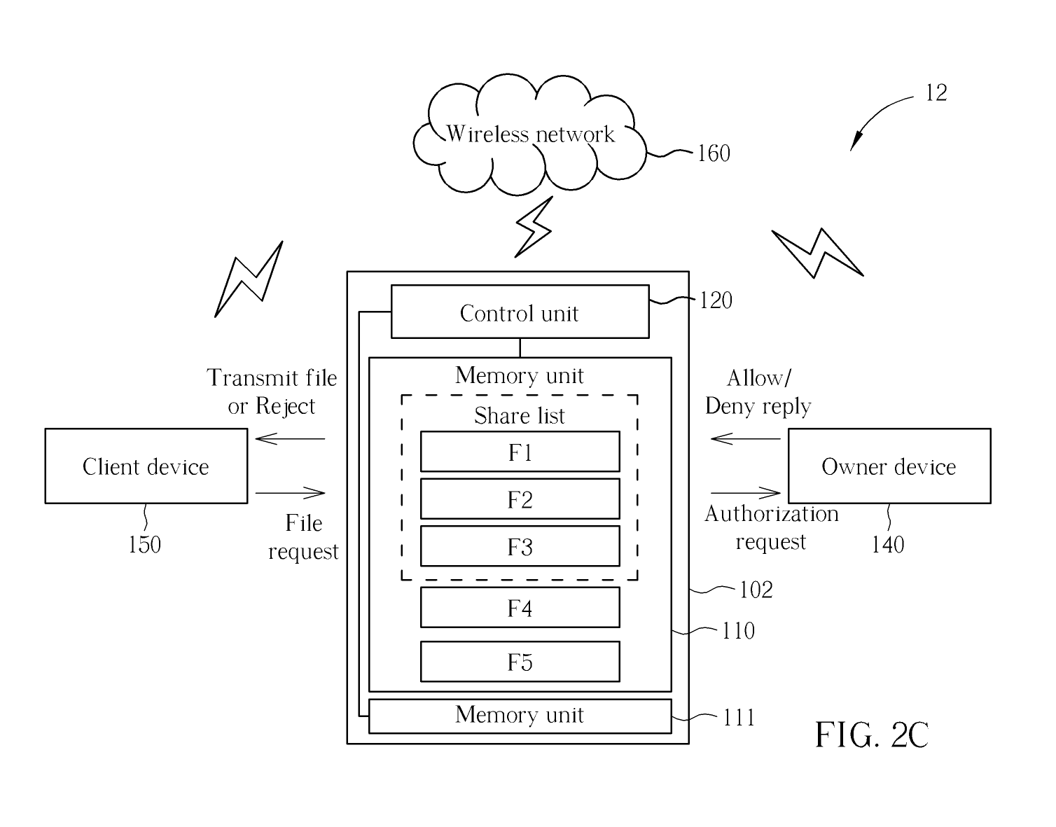

Please refer to FIG. 1 and FIG. 2A. FIG. 1 is a diagram showing a network storage device 100 of the present embodiment, and FIG. 2A is a diagram illustrating a wireless file transferring system 10 performing a method for accessing a file in the network storage device 100 of the present embodiment. As shown in the figures, the network storage device 100 comprises a memory unit 110 for storing data and some other information for operation of the network storage 100, and a control unit 120 for controlling access of the data and the information stored in the memory unit 110. An owner electronic device 140 and a client electronic device 150 are coupled to the network storage device 100 via a wireless network 160. The wireless network 160 can be achieved by any connecting method for wireless data transferring, such as Internet, Ethernet, WiFi, Bluetooth, Infrared and the like.

The owner electronic device 140 is an electronic device with authority to manage the network storage device 100. For example, the owner electronic device 140 can set files F1-F3 to be visible in the network storage device 100 in order to share the visible files F1-F3 with other electronic devices, and other files F4 and F5 besides the visible files F1-F3 are invisible to other electronic devices. In the present embodiment, when the client electronic device 150 connects to the network storage 100 via the wireless network 160, the client electronic device 150 can review the shared list first, such as the visible files F1-F3, and then transmit a file request to the network storage device 100 via the wireless network 160 for accessing/downloading the visible files F1-F3 stored in the memory unit 110 of the network storage device 100. It should be noted in the present embodiment that a single file request might include requesting to access/download a plurality of files in the network storage device 100. After receiving the file request from the client electronic device 150, the control unit 120 of the network storage device 100 transmits an authorization request to the owner electronic device 140 via the wireless network 160 for asking whether the visible files F1-F3 are accessible by the client electronic device 150. Even if the visible files F1-F3 are set to be shared, a user of the owner electronic device 140 still has authority to further determine which visible file is accessible by the client electronic device 150. For example, if the client electronic device 150 wants to access the visible file F2, and the user of the owner electronic device 140 does not want to share the file F2 with a user of the client electronic device 150, after receiving the file request the owner electronic device 140 can transmit a deny reply to the network storage device 100 via the wireless network 160, such that the network storage device 100 will reject the file request from the client electronic device 150. If the client electronic device 150 wants to access the visible file F1, and the user of the owner electronic device 140 determines to share the file F1 with the user of the client electronic device, the owner electronic device 140 can transmit an allow reply to the network storage device 100 via the wireless network 160, such that the control unit 120 of the network storage device 100 will then determine to deliver the file F1 to the client electronic device 150 via the wireless network 160 according to the allow reply.

According to the above arrangement, the user of the owner electronic device 140 does not need to set the authority level of each user one-by-one in advance. The owner electronic device 140 can first determine a list of the visible files stored in the network storage device 100 to be shared, and then determine which visible file is accessible by which user according to the authorization request.

In addition, the network storage device 100 can store the authorization request while the owner electronic device 140 is decoupled from the network storage device 100 via the wireless network 160 (ex. out of range of the wireless network 160), and then transmit the authorization request to the owner electronic device 140 when the owner electronic device 140 is re-coupled to the network storage device 100 via the wireless network 160. Similarly, the network storage device 100 can store the allow/deny reply from the owner electronic device 140 while the client electronic device 150 is decoupled from the network storage device 100 via the wireless network 160, and then transmit the allow/deny reply to the client electronic device 140 when the client electronic device 140 is re-coupled to the network storage device via the wireless network 160. The above mentioned authorization request of the network storage device 100 and the allow/deny reply from the owner electronic device 140 can be temporarily stored in the memory unit 110 of the network storage device 100.

Please refer to FIG. 2B, FIG. 2B is a diagram illustrating another wireless file transferring system 11 performing a method for accessing a file in a network storage device 101 of another embodiment . As shown in FIG. 2B, the memory unit 110 of the network storage device 101 can be separated into at least two storage areas 112 and 114. The first storage area 112 of the memory unit 110 stores the visible and invisible files F1-F5 as previously mentioned, and the authorization request of the network storage device 101 and/or the allow/deny reply from the owner electronic device 140 are temporarily stored in the second storage area 114 when the owner electronic device 140 or the client electronic device 150 are decoupled from the network storage device 101 via the wireless network 160.

Also, please refer to FIG. 2C, FIG. 2C is a diagram illustrating another wireless file transferring system 12 performing a method for accessing a file in a network storage device 102 of another embodiment. As shown in FIG. 2C, the authorization request of the network storage device 101 and/or the allow/deny reply from the owner electronic device 140 are temporarily stored in another memory unit 111 when the owner electronic device 140 or the client electronic device 150 are decoupled to the network storage device 102 via the wireless network 160. The memory unit 111 is independent to the memory unit 110 and electrically coupled to the control unit 120.

Furthermore, besides directly transmitting the file to the client electronic device 150, the network storage device 100 can also transmit a stream of the file to the client electronic device 150 via the wireless network 160, such that the network storage device 100 can be utilized to broadcast a media file, such as a music or video file, to a plurality of electronic devices. The owner electronic device 140 can determine which visible file is accessible by other electronic devices in a specific period of time according to a broadcast schedule.

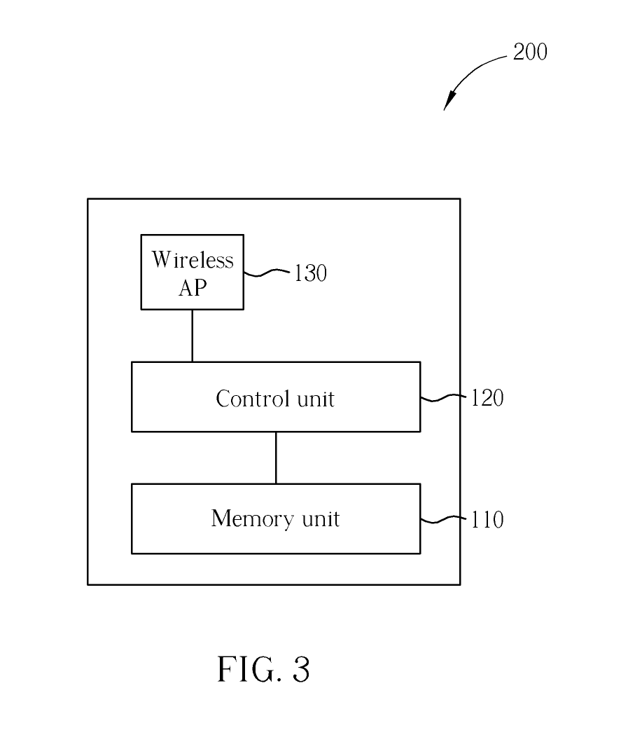

Please refer to FIG. 3. FIG. 3 is a diagram showing another network storage device 200 of the present embodiment. As shown in FIG. 3, the network storage device comprises a memory unit 110 for storing data and some other information for operation of the network storage 200, a control unit 120 for controlling access of the data stored in the memory unit 110, and a wireless access point unit 130 electrically connected to the control unit 120 for providing the wireless network 160, such that the owner electronic device 140 and the client electronic device 150 can directly couple to the network storage device 200 via the wireless network 160.

In the above embodiments, the owner electronic device 140 and the client electronic device 150 are coupled to the network storage device 100, 200 via the wireless network 160, but in other embodiments, the owner electronic device 140 and the client electronic device 150 can be coupled to the network storage device 100, 200 via any other type of network, such as a wired local area network.

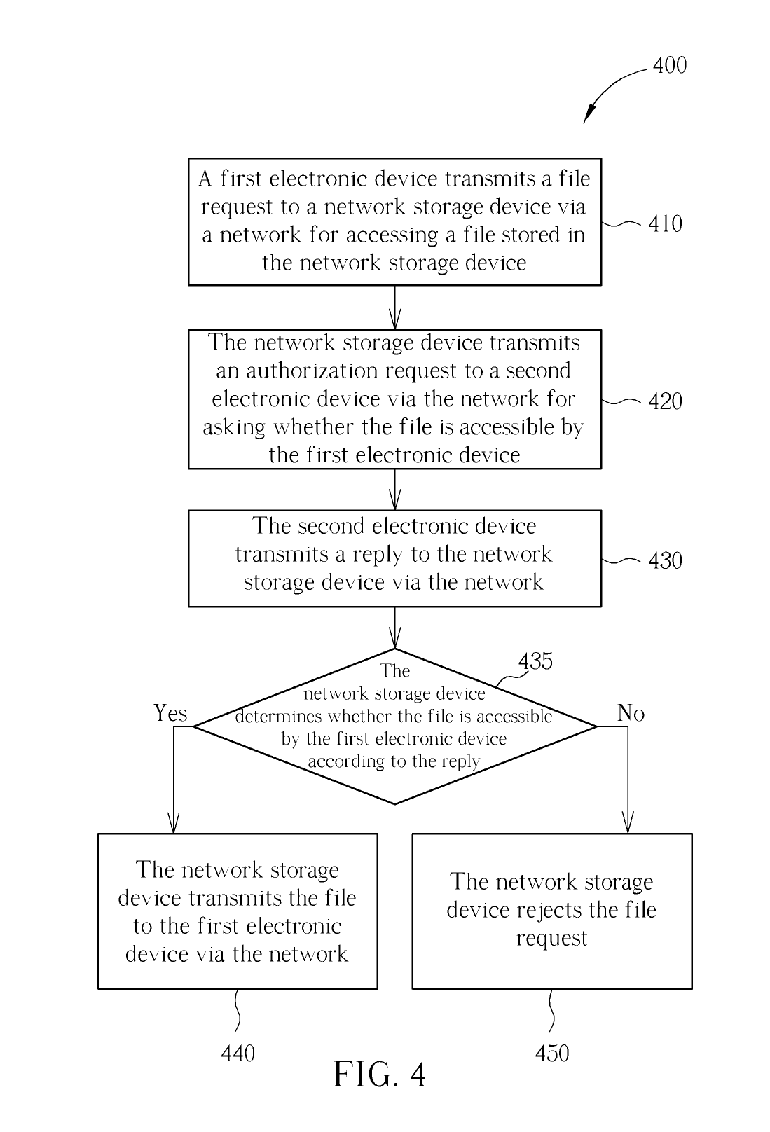

Please refer to FIG. 4, which is a flowchart 400 of the method of the present embodiment for accessing files in the network storage device. The flowchart 400 comprises the following steps:

Step 410: A first electronic device transmits a file request to a network storage device via a network for accessing a file stored in the network storage device;

Step 420: The network storage device transmits an authorization request to a second electronic device via the network;

Step 430: The second electronic device transmits a reply to the network storage device via the network;

Step 435: The network storage device determines whether the file is accessible by the first electronic device according to the reply;

Step 440: When the reply indicates that the file is accessible by the first electronic device, the network storage device transmits the file to the first electronic device via the network; and

Step 450: When the reply indicates that the file is not accessible by the first electronic device, the network storage device rejects the file request.

Basically, to achieve the same result, the steps of the flowchart 400 need not be in the exact order shown and need not be contiguous. That is, other steps can be inserted therebetween.

In contrast to the prior art, the method and the network storage device of the present invention are capable of sharing files to different users while keeping data security without presetting the authority level of each user one-by-one, which is convenient and time-saving.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A file accessing method via a network for a network storage device having at least one file stored therein, comprising:
receiving a file transmitting request from a first electronic device via the network for accessing the file;
transmitting an authorization request corresponding to the file transmitting request to a second electronic device via the network;
receiving a reply corresponding to the authorization request from the second electronic device; and
transmitting the file to the first electronic device via the network when the reply notices that the file is accessible.

2. The method of claim 1, further comprising rejecting the file transmitting request from the first electronic device when the reply notices that the file is not accessible.

3. The method of claim 1, further comprising a step of setting the file to be visible in the network storage device before the step of receiving the file transmitting request from the first electronic device via the network for accessing the file.

4. The method of claim 1, further comprising storing the authorization request in the network storage device before the step of transmitting the authorization request corresponding to the file transmitting request to the second electronic device via the network.

5. The method of claim 1, wherein the step of transmitting the file to the first electronic device via the network comprises transmitting a stream of the file to the first electronic device via the network.

6. A network storage device, comprising:
a first memory unit, for storing data; and
a control unit, for controlling access of the data stored in the first memory unit;
wherein when a first electronic device transmits a file request to the network storage device via a network for accessing a file stored in the first memory unit, the control unit transmits an authorization request to a second electronic device via the network for asking whether the file is accessible by the first electronic device; and
wherein when the second electronic device transmits a reply to notice the network storage device that the file is accessible by the first electronic device, the control unit transmits the file to the first electronic device via the network.

7. The network storage device of claim 6, wherein the network is a wireless network.

8. The network storage device of claim 6, further comprising a wireless access point (AP) unit electrically connected to the control unit for coupling to the first electronic device and the second electronic device via the network wirelessly.

9. The network storage device of claim 6, wherein the first memory unit comprising:
a first storage area, for storing the file; and
a second storage area, for storing the authorization request and/or the reply from the second electronic device.

10. The network storage device of claim 6, further comprising a second memory unit for storing the authorization request and/or the reply from the second electronic device.

11. A data transmitting system, comprising:
a network storage device, comprising:
a first memory unit, for storing at least one file; and
a control unit, coupled to the first memory unit for controlling access of the at least one file stored in the first memory unit;
a client electronic device, coupled to the network storage device via a network; and
an owner electronic device, coupled to the network storage device via the network;
wherein when the client electronic device transmits a file request to the network storage device via the network for accessing the at least one file stored in the first memory unit, the control unit transmits an authorization request to the owner electronic device via the network for asking whether the at least one file is accessible by the client electronic device; and
wherein when the owner electronic device transmits a reply to notice the network storage device that the at least one file is accessible by the client electronic device, the control unit transmits the at least one file to the client electronic device via the network.

12. The network storage device of claim 11, wherein the network is a wireless network.

13. The network storage device of claim 11, further comprising a wireless access point (AP) unit electrically connected to the control unit for coupling to the client electronic device and the owner electronic device via the network wirelessly.

14. The network storage device of claim 11, wherein the first memory unit comprising:
a first storage area, for storing the at least one file; and
a second storage area, for storing the authorization request and/or the reply from the owner electronic device.

15. The network storage device of claim 11, further comprising a second memory unit for storing the authorization request and/or the reply from the owner electronic device.

16. A file accessing method via a network for a network storage device, comprising:
generating a file request to the network storage device;
generating an authorization request in response to the file request to ask whether a file quested by the file request is accessible; and
generating a reply corresponding to the authorization request to determine whether the file is able to be delivered from the network storage device.

17. The method of claim 16, further comprising setting the file to be visible before the step of generating the file request to the network storage device.
